(19) United States
(12) Patent Application Publication
(10) Pub. No.: US 2018/0247010 A1
(43) Pub. Date: Aug. 30, 2018

(54) INTEGRATED METHOD AND SYSTEM FOR IDENTIFYING FUNCTIONAL PATIENT-SPECIFIC SOMATIC ABERATIONS USING MULTI-OMIC CANCER PROFILES

(71) Applicants: KONINKLIJKE PHILIPS N.V., Eindhoven (NL); CASE WESTERN RESERVE UNIVERSITY (CWRU), CLEVELAND, OH (US)

(72) Inventors: Abolfazl Razi, Flagstaff, AZ (US); Vinay Varadan, Westlake, OH (US); Nevenka Dimitrova, Pelham Manor, NY (US); Nilanjana Banerjee, Armonk, NY (US)

(21) Appl. No.: 15/755,878

(22) PCT Filed: Aug. 26, 2016
(86) PCT No.: PCT/IB2016/055092

§ 371 Date: Feb. 27, 2018

Related U.S. Application Data
(60) Provisional application No. 62/210,502, filed on Aug. 27, 2015.

(51) Int. Cl. G06F 19/12; G06F 19/18

(52) U.S. Cl. CPC G06F 19/12; G06F 17/18; G06F 19/18

(57) ABSTRACT

A system and method for determining the functional impact of somatic mutations and genomic aberrations on downstream cellular processes by integrating multi-omics measurements in cancer samples with community-curated biological pathways are disclosed. The method comprises the steps of extracting biological pathway information from well-curated biological pathway sources, using the pathway information to generate an upstream regulatory parent sub-network tree for each gene of interest, integrating measurement-based omic data for both cancer and normal samples to determine a nonlinear function for each gene expression level based on the gene's epigenetic information and regulatory network status, using the nonlinear function to predict gene expression levels and compare activation and consistency scores with inputted patient-specific gene expression data, and using the patient-specific gene expression predictions to identify significant deviations and inconsistencies in gene expression levels from expected levels in individual patient samples to identify potential biomarkers in providing predictive information in relation to cancer and cancer treatment.

### RELATED APPLICATIONS

This application claims priority to U.S. Provisional Application No. 62/210,502, filed Aug. 27, 2015, which is specifically incorporated herein by reference in its entirety.

### FIELD OF THE INVENTION

The present invention relates to a data-driven integrative system and method for providing patient-specific gene expression predictions by building a gene-gene regulatory influence network that incorporates community-curated biological pathway network information and omics data, such as RNAseq-based expression data, copy number variation (CNV) data, and DNA methylation data, and comparing with multi-omic patient-specific measurements, including RNAseq-based gene expression, array-based DNA methylation (epigenetic) and SNP-array based somatic copy-number alterations (sCNA). More particularly, the patient-specific gene expression predictions are used to identify significant deviations and inconsistencies in gene expression levels from expected levels in individual patient samples for providing predictive information in relation to cancer and cancer treatment.

### BACKGROUND OF THE INVENTION

The pathobiology of cancer is associated with significant aberrations within the natural complex biological processes governing the growth and differentiation of normal cells. However, there exists significant heterogeneity within cancers originating even within the same tissue type, possibly reflecting the multiple ways in which the normal signaling networks can be pathologically altered. This heterogeneity underlies the significant challenges posed in the development of diagnostic and theranostic biomarkers as well as potential therapeutic interventions in oncology, and points to the need for a systems-level understanding of cancer etiology and progression.

For instance, the ERBB2 gene which encodes a member of the epidermal growth factor (EGF) receptor family of receptor tyrosine kinases and plays a significant role in cell proliferation is highly overexpressed in multiple cancers, especially breast, gastrointestinal and ovarian cancers. This gene is deregulated in approximately 20% of breast cancer and in most cases its overexpression is associated with copy number amplifications, and has resulted in the definition of a specific subtype of breast cancer named after this gene, HER2-positive breast cancer. Despite the availability of a targeted therapeutic intervention for this particular subtype of breast cancer, namely Herceptin, the response rate of breast cancer patients to this therapy remains in the 50-55% range. This heterogeneity in response points to the existence of other genetic modulators of tumor progression. Indeed, it has been shown that aberrations in the AKT/PI3K pathway, such as deletions of the tumor suppressor gene PTEN, and mutations in the PIK3CA gene result in resistance to Herceptin. However, no systems-level pathway model currently exists that can integrate all of these factors into a single integrative biomarker for therapy resistance.

While the tumorigenic effects of specific recurrent mutations in known cancer driver-genes is well-characterized, not much is known about the functional relevance of the vast majority of recurrent mutations observed across cancers. Computational methods to assess the functional relevance of mutations largely depend on either estimating their impact on protein structure or are based on the relative frequency of their occurrence as compared to background mutational processes. In order to shed light on the potential impact of the mutations on downstream cellular processes, recent approaches have attempted to identify functional effects of genomic aberrations by integrating multi-omics measurements in cancer samples with community-curated biological pathway networks. However, the vast majority of these approaches tend to overlook key biological considerations including unequal and possibly nonlinear influences of multiple regulatory factors on downstream gene transcription and the tissue-specificity of pathway interactions.

Several computational frameworks have been developed in order to evaluate the functional significance of mutations or genomic aberrations in cancer samples. While methods based on the inference of mutational effects on protein structure have been widely used in the community, recent work has focused on determining driver mutations in genes by evaluating the relative frequency of a gene being mutated as compared to background mutation processes. Recognizing that silent mutations are typically rare for any candidate gene, likely resulting in inaccurate background mutation rate estimates, MutSigCV attempted to leverage genes with similar genomic properties to the candidate gene in order to improve the background mutation rate estimates. Other methods aim to identify subnetworks that are frequently hit by somatic mutations within a given cancer subtype. However, these approaches do not provide mechanistic insights into the downstream deregulatory or signaling effects of somatic aberrations. These shortcomings have led to network-based methods, where the well-curated biological interactions among cell entities (e.g., genes, RNAs, proteins, protein complexes and miRNAs) are incorporated into the model in terms of pathway networks. Other studies focus solely on the association between cancer clinical outcomes and the activation level of molecular entities such as gene and protein expression levels but do not explicitly model the functional effects of mutations in cancer biology. Recently, PARADIGM-SHIFT was proposed to integrate pathway regulatory networks with multi-omics data to model the functional impact of somatic mutations on the activity of individual nodes in the pathway. The functional effect of a somatic aberration in any given protein is inferred based on the difference in activity of the corresponding node obtained once from its upstream regulatory network and again from its downstream target nodes.

Although different in development, there are common drawbacks shared among these methods, which is their absolute reliance on the biological pathway networks, hence utilization of these methods should be restricted to well-curated pathway networks and not recommended for partially validated or molecular networks that were derived from different tissue contexts. More importantly, these techniques typically presume that all parent genes contribute equally to the corresponding interaction, thus overlooking the potential for variations in the strength of influence between the interactions among the network nodes. For instance, if multiple genes appear as transcriptional regulators of a specific target gene, they are considered to contribute equally to the expression level of the target gene, which is biologically questionable. In reality, the pairwise influence among adjacent nodes can be extremely different. The heterogeneity among links is considered in the HotNet algorithm, which intends to discover this heterogeneity through defining a measure of pairwise influence among gene pairs based on the network topology. However, the actual pairwise influence heterogeneity arising from complex underlying regulatory interactions is not fully extractable from the putative pathway network topology.

Since pathway level aberrations can result from multiple sources, such as somatic mutations, copy-number alterations, epigenetic variations and the regulatory gene expression changes, jointly modeling these sources of variability is essential to developing comprehensive pathway-based predictive models of use in oncology. Furthermore, with the recent advances in low-cost genome-wide data acquisition techniques in molecular biology, measurements of the different sources of variability are becoming increasingly available. However, modeling frameworks that can fully utilize the information present in these multi-omics profiles are lacking in both the research and diagnostic communities. Development of computational frameworks to integrate various data sources, including RNA expression level, copy number variations, DNA methylation patterns, and somatic mutations, with the objective of finding clinically useful biomarkers is therefore an essential need in the oncology community.

Recently, several integrative approaches were proposed to incorporate various sources of information into a unified framework to facilitate early cancer diagnosis, clinical outcome prediction and more relevant therapeutic interventions. The majority of these approaches take one of the two extreme perspectives of either; i) totally ignoring the conceptual biological information and relying solely on data-driven techniques, or ii) fully trusting the conceptual biological information via incorporating a network of interacting molecular entities. Ignoring biological interactions among the cell molecular entities (e.g., genes and proteins) in the first approach is highly inefficient in finding biologically relevant subsets of entities with significant collective predictive powers, due to the potential of data over-fitting. Indeed, this problem is particularly accentuated in cancer research since the number of cancer samples in any given study tends to be an order of magnitude lower than the number of molecular features measured. On the other hand, a full reliance on descriptive biological networks ignores their limitations: the pathway networks are typically constructed based on experimental evidence in a specific cellular context, which may not always be translatable to other tissue and pathological contexts.

The within invention takes a hybrid approach and incorporates both measurement-based omics data and partially trusted pathway information into a unified framework to build a gene-gene influence network, which is capable of predicting a particular gene expression level given the regulatory network status. This framework not only refines and extends our knowledge of tissue-specific protein-protein interactions but also provides patient-specific predictions and conditional distributions of network entities (e.g., genes). These patient-specific gene expression predictions are then leveraged to find significant deviations and inconsistencies in gene expression levels from expected levels in individual patient samples, thus allowing for the discovery of potential associations with phenotypes such as therapy response and prognosis.

This invention overcomes several significant limitations in integrating biological information and various molecular measurement data sources into a unified network-based computational framework. This leads to revealing more relevant patient-specific malfunctioning genes and perturbed biological processes.

For example, the method of this invention incorporates the biological information and reports only genes that show significant inconsistency with the underlying network-based predictions and patient-specific measurements. This approach, therefore, results in higher specificity as well as sensitivity in identifying the most functionally-relevant genes associated with the phenotype in consideration.

Also, the current set-based methods take biological information into account by first annotating sets of genes that are jointly associated with a particular phenotype or cellular/biological process based on a prior biological knowledge. However, set-based methods are not capable of adaptive integration and the user is required to include the biological information manually via forming potentially more relevant gene sets. In contrast, the within invention does not require any prior information about the cancer biology. The method develops a gene regulatory network for each gene from the pathway network annotations. The resulting pathway subnetworks associated with a phenotype provide functional insights along with robust biomarkers and is therefore widely applicable across cancers.

Currently available network-based methods such as Paradigm, Pathologist and SPIA aim at integrating pathway information with measurement data, in order to identify perturbed pathways and genes exhibiting significant deviations from predictions obtained from the network. These approaches have two important drawbacks. Firstly, these approaches fully trust the biological pathway network relationships without allowing for the potential of tissue-specific variations in pathway network connectivity. The second and even more important issue is that these techniques overlook the potential for functional heterogeneity amongst the interaction links in the network. They presume an equal influence of all the direct parent nodes, while in reality the influence of some regulatory parent genes may be significantly higher than the other parent genes.

The within method and system do not rely fully on the pathway network but rather refines the influence network by assigning different coefficients to the network edges that are learned from the multi-omics data. See, e.g., Tables 2 and 3; network edges representing upstream regulators are captured using the coefficients for ancestors; cis-regulatory influences are captured as CNV and Methylation coefficients. Further, loosely connected links are removed. Therefore, our method highlights and discovers the heterogeneous relations among network nodes (e.g., genes, RNAs, proteins).

In further contrast, our method uses both biological pathways and multi-omics measurement data to capture not only the topology but also the strength of the influence between nodes in the network as mentioned above. Therefore, it provides a more accurate and realistic influence among network nodes. Secondly, the within method is not limited to finding paths that are frequently affected by somatic mutations, but also finds the malfunctioning nodes.

In order to address these issues, the process of the invention, that we refer to as Information Flow impacted by Mutations (“InFlo-Mut”), incorporates multi-omics measurements, including RNAseq-based gene expression, array-based DNA methylation (epigenetic) and SNP-array based somatic copy-number alterations (sCNA), and biological pathway network information to build a gene-gene regulatory influence network. InFlo-Mut learns the pairwise influence of the regulatory nodes on the target genes from molecular profiles of normal and cancer tissues. To infer activity of the nodes in a new sample, InFlo-Mut uses the network coefficients, which are already learned from the training dataset. This is realized through learning a non-linear Bayesian model to predict the expression level of any given gene using its own sCNA and methylation profiles along with upstream regulatory influences inferred from biological pathway networks. This approach not only solves the issue of unequal parent node contributions by capturing heterogeneous pairwise influence coefficients, but also is capable of learning non-linear relations among the nodes. InFlo-Mut also allows for the assessment of the association between the somatic mutations with the downstream target genes, in order to reveal subset of genes whose mutations have higher impact on dysregulating the target genes. We demonstrate the robustness and biological validity of InFlo-Mut by applying it to two large multi-omics datasets on breast and colon cancers and uncover the potential modulatory effects of mutations across genes in key oncogenic pathways in these diseases.

### SUMMARY OF THE INVENTION

In particular, an object of the present invention is to provide a system and method that solves the above-mentioned problems of the prior art by integrating curated pathway networks with multi-omic biological information and various molecular measurement data sources, into a unified network-based computational framework to identify the impact of somatic mutations. It is also an object of the present invention to provide a system and method for providing patient-specific gene expression predictions and identifying the significant deviations and inconsistencies in patient gene expression levels from predicted levels, to identify more relevant malfunctioning genes and perturbed biological processes. It is a further object of the present invention to identify potential associations with phenotypes such as therapy response and prognosis. It is also an object of the present invention to provide an alternative to the prior art.

Thus, the above-described object and several other objects are intended to be obtained in a first aspect of the invention by providing a system and method for identifying and reporting potential somatic aberrations driving dysregulated genes, such method comprising the steps of:

determining a primary dataset of upstream regulatory parent gene information for each specific target gene of interest by obtaining biological network pathway information from well-curated publicly available pathway networks and inputting the pathway information onto a processor configured to receive the pathway information;

determining, by applying, a regulatory tree for each specific target gene that captures the relationship between the gene's expression level with its own genomic and epigenetic status as well as its upstream transcriptional regulators; the gene of interest resides in the root node and the leaves of the tree represent all of the genes that potentially regulate its transcription either directly or indirectly through intermediate signaling partners;

determining a second dataset of measurement-based omics data, such as RNAseq expression data, copy number variation data and DNA methylation data, and inputting the measurement-based omics data onto a processor configured to receive such data,

applying computational techniques, by computer, to learn a non-linear function for each gene of interest based on the gene's epigenetic information and regulatory network status, in order to relate that particular gene expression level to the measurements associated with the regulatory tree leaves; the parameters of the non-linear function are estimated using a Bayesian inference method incorporating a novel depth penalization mechanism to capture the potentially stronger regulatory impact of nodes closer to the root node in the tree;

applying analytical techniques, by computer, to predict expression levels for each gene of interest;

determining patient-specific information relating to observed expression levels for the desired target genes, and inputting the patient-specific information as a third dataset, the patient—specific information including new cancer sample data such as RNA expression data, CNV data, methylation data and somatic mutation data;

using the patient-specific information and the predicted expression level information, calculating relative patient-specific inconsistency scores between the predicted and observed expression levels for the desired target genes in a given sample;

evaluating the activation and inconsistency scores obtained for all test samples to discover statistically significant associations between inconsistencies in the target gene expression level with the somatic mutations in the upstream regulatory network of that particular gene.

According to a second aspect of the invention a system is provided for utilizing the statistically significant associations between inconsistencies in the target gene expression level in individual patient samples with somatic mutations in the upstream regulatory network, to identify patient-specific biomarkers, such system comprising an integrated, unified network for identifying significant deviations and inconsistencies in gene expression levels, comprising;

a primary dataset of upstream regulatory parent gene information for each specific target gene of interest obtained from well-curated biological network pathway information, the primary dataset contained on a processor configured to receive said pathway information;

a regulatory tree for each specific target gene that captures the relationship between the target gene's expression level with said target gene's own genomic and epigenetic status, as well as its upstream transcriptional regulators, the gene of interest resides in the root node and the leaves of the tree represent all of the genes that potentially regulate its transcription either directly or indirectly through intermediate signaling partners, said tree determined from the primary dataset;

a second dataset of measurement-based omics data, such as RNAseq expression data, copy number variation data and DNA methylation data, the second dataset also located on a processor configured to receive such data,

a non-linear function learned for each target gene determined from said target gene's epigenetic information and regulatory network status, said non-linear function relating that particular target gene's expression level to measurements associated with said regulatory tree; wherein the parameters of said non-linear function are estimated using a Bayesian inference method incorporating a novel depth penalization mechanism to capture the potentially stronger regulatory impact of nodes closer to the root node in the tree;

a third dataset of patient-specific information relating to observed expression levels for the target genes, the patient-specific information including new cancer sample data such as RNA expression data, CNV data, methylation data and somatic mutation data;

wherein, expression levels of the target genes are determined utilizing the non-linear function, and relative patient-specific inconsistency scores are determined between the predicted and observed expression levels for the target genes in a given sample; and

wherein activation and inconsistency scores a r e determined a third dataset of patient-specific information relating to observed expression levels for the target genes, the patient-specific information including new cancer sample data such as RNA expression data, CNV data, methylation data and somatic mutation data;

wherein, expression levels of said target genes are determined utilizing the non-linear function, and relative patient-specific inconsistency scores are determined between the predicted and observed expression levels for the target genes in a given sample; and

wherein activation and inconsistency scores a r e determined for all test samples whereby statistically significant associations between inconsistencies in the target gene expression level with the somatic mutations in the upstream regulatory network of that particular gene are identified.

### BRIEF DESCRIPTION OF THE DRAWINGS

The methods according to the invention will now be described in more detail with regard to the accompanying figures. The figures showing ways of implementing the present invention and are not to be construed as being limiting to other possible embodiments falling within the scope of the attached claims.

FIG. 1 is an overview of the within method illustrating a pathway of steps that integrates gene regulatory and/or signaling pathway networks with measurement-based omics data to provide patient-specific gene expression predictions. The steps of this aspect of the invention are: i) extracting regulatory trees for each un-isolated target gene, ii) learning a non-linear function for each target gene using a training dataset, iii) predicting gene expression values for target genes of interest and calculating activation and consistency scores and iv) functional mutation impact analysis;

FIG. 2 illustrates a regulatory tree generated using the regulatory interactions derived from pathway databases for a sample gene PPP3CA;

FIG. 3 is a histogram of ancestors counts for genes, showing the distribution of the number of ancestors up to level 2 for all genes in the pathway networks and illustrating that most genes have somewhere between 10 and 50 upstream regulators;

FIG. 4 is a graph of a nonlinear function including centered sigmoid and soft thresholding to capture two potential nonlinear effects: i) near mean-sensitivity and ii) near-mean ignorance; the x-axis denotes measured copy-number or DNA methylation levels; the y-axis denotes the extent of influence of the measurement on gene expression. In the case of near mean-sensitivity, small changes in measured DNA Methylation near the mean result in large deviations in gene expression. However, in near-mean ignorance, small changes in copy-number near the mean do not result in major changes in gene expression;

FIG. 5. illustrates JUN gene expression level prediction versus observation for CRC normal and tumor samples. Cancer samples (*) show widespread inconsistency as compared to normal samples (*). The method prediction is provided in terms of posterior mean (o) and confidence interval up to 3 standard deviations presented by error bars T;

FIG. 6 illustrates inconsistency scores for all genes for BRC and CRC tumor samples;

FIG. 7 is a flowchart summarizing a method of this invention for identifying patient-specific malfunctioning genes based on significant inconsistencies between network-based predictions and patient-specific measurement;

FIG. 8 is a graphical representation of the results of a method of the invention illustrating the impact of somatic mutations on target gene expression in colon cancer samples;

FIG. 9 is a histogram of the RNA expression for Gene PTEN;

FIG. 10 illustrates predictions versus observations for sample genes MYB, GATA3, PTEN and ERBB2;

FIG. 11 illustrates RNA expression level versus copy number variation CNV for gene ERBB2; and

FIG. 12 illustrates the impact of somatic mutations in the upstream regulatory subnetwork of PTEN on its gene expression inconsistency.

### DETAILED DESCRIPTION OF THE INVENTION

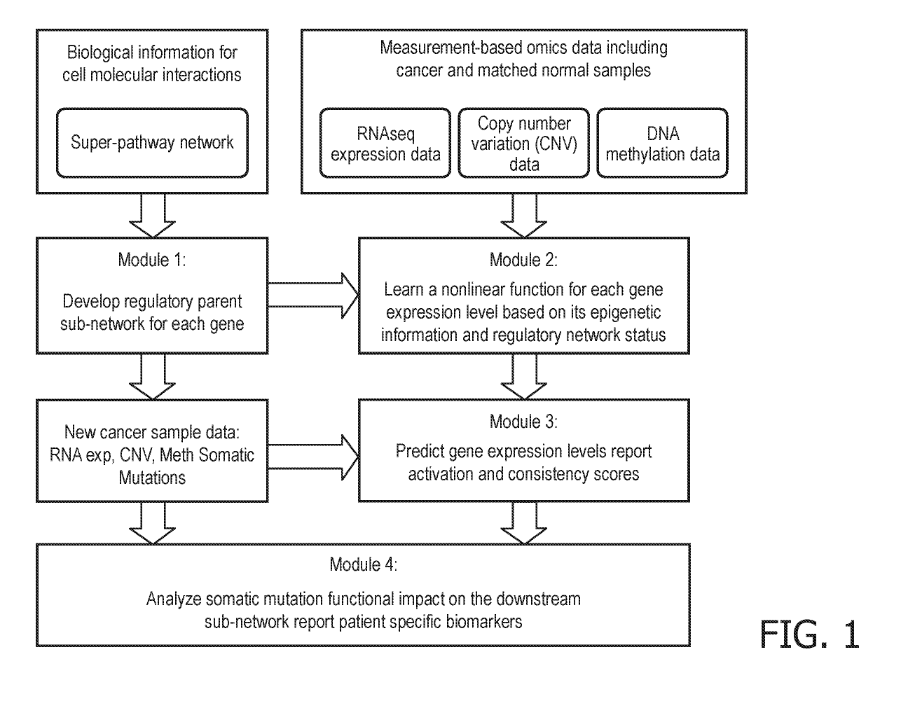

The present invention provides a system and method for integrating multi-omic biological information and various molecular measurement data sources into a unified network-based computational method for providing patient-specific gene expression predictions and identifying significant deviations and inconsistencies in gene expression levels from expected levels. The present invention is described in further detail below with reference made to FIGS. 1-12.

According to an embodiment of the present invention, a flowchart presenting the overall block-diagram of the method for providing patient-specific gene expression predictions, identifying significant deviations and inconsistencies in gene expression levels from expected levels and reporting patient-specific biomarkers, is set forth by the steps, or modules, outlined in FIG. 1. As illustrated in FIG. 1, the method consists of four main sequential steps or modules to identify and report potential somatic aberrations driving dysregulated genes. In the first step, Module 1, a regulatory tree is extracted for each gene of interest from the pathway network that captures the relationship between the gene's expression level with its own genomic and epigenetic status, as well as its upstream transcriptional regulators. The gene of interest resides in the tree root node and the tree represents a network of upstream regulators of the gene's transcription. The leaves of the tree represent all of the genes that potentially regulate the gene's transcription, either directly or indirectly, through intermediate signaling partners. We use the terms “ancestor genes” or simply “ancestors” to refer to these genes.

In Module 2, the second step, we determine a non-linear function for each gene in order to relate that particular gene expression level to measurements associated with the regulatory tree leaves. Thus, each tree subnetwork is used to learn a non-linear function to predict the corresponding gene expression level from its own epigenetic information (e.g., DNA Methylation and Copy Number) and its regulatory ancestor gene expression levels. The parameters of the non-linear function are estimated using a Bayesian inference method incorporating a novel depth penalization mechanism to capture the potentially stronger regulatory impact of nodes closer to the root node of the tree. This provides a bank of functions each corresponding to a specific gene in the context of specific tissue type. This function database is learned once and can be used for patient-specific analysis in the two subsequent steps performed by Modules 3 and 4.

In step 3, Module 3 calculates relative patient-specific inconsistency scores between the predicted and observed expression levels for the desired target genes in a given sample. That is, Module 3 receives information for a given patient and performs prediction of gene expression levels for all genes within the regulatory network using the function bank. This module further calculates the consistency scores for each gene by comparing the actual measurement of gene expression, or observed value, with the predicted value. In the fourth step, Module 4, evaluates the activation and inconsistency scores obtained for all test samples to discover statistically significant associations between the inconsistencies in the target gene expression level with the somatic mutations in the upstream regulatory network of that particular gene. Thus, Module 4 identifies the genes whose expression levels are significantly inconsistent with the prediction values obtained from the regulatory network. These genes are likely malfunctioning due to copy number aberrations in the gene or somatic mutations in its ancestors. Module 4 further provides statistics to evaluate the significance of ancestor gene mutations that potentially are associated with the inconsistencies in the child gene expression level.

Module 1: Incorporating Pathway Networks—Regulatory Tree Construction

Gene transcription is a complex biological process, which is regulated at different levels through multiple interacting proteins and complexes as well as the extent of DNA methylation and the harboring DNA segment copy number, as annotated in biological pathway databases. Pathway networks are widely used to present the intra-cellular interactions and gene regulatory networks in a network format. The network builds a directed graph of nodes and edges. The nodes may consist of a diverse range of entities such as genes, proteins, RNAs, miRNAs, protein complexes, signal receptors, and even abstract processes such as apoptosis, meiosis, mitosis and cell proliferation. The network edges determine the pairs of interacting nodes and specify the type of each interaction. Several publicly available pathway networks are developed to model intra cellular activities between various species and tissue types.

In this invention, we use a comprehensive network that brings together pathways from various well-curated pathway sources including NCI-PID, Biocarta and Reactome. This “super pathway network” consists of six node types including; proteins or the corresponding genes, RNAs, protein complexes, gene families, miRNAs, and abstracts. These nodes interact with one another in six different ways of; i) positive transcription, ii) negative transcription, iii) positive activation, iv) negative activation, v) gene family membership, and vi) being a component of a protein complex. Usually, transcription is terminated only to genes represented by the corresponding proteins, while activation is applicable to all node types.

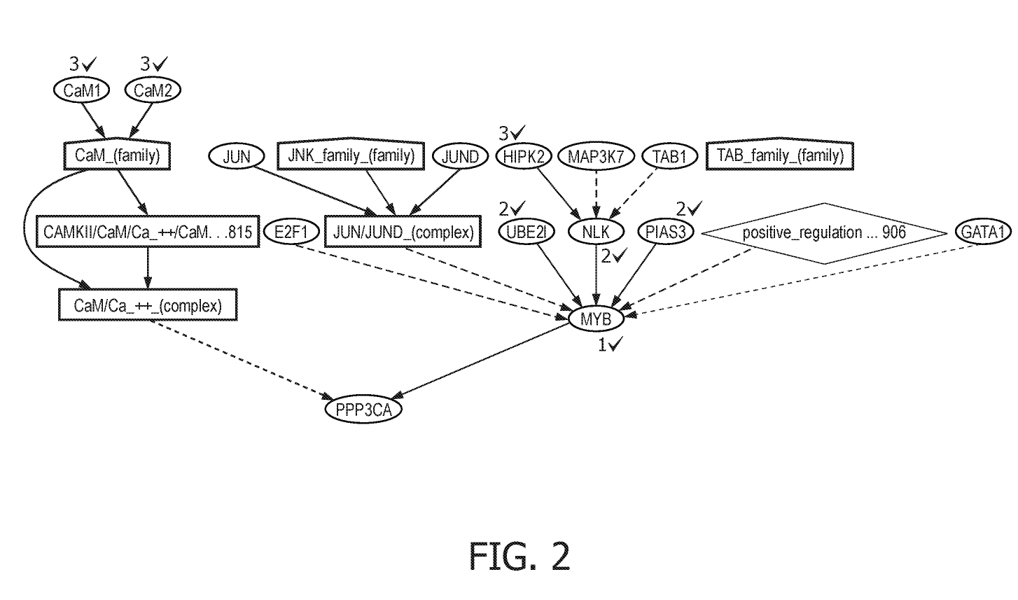

In order to learn a function relating a gene's mRNA expression level to its epigenetic parameters (DNA methylation and copy number variation), as well as its regulatory network, we extract the regulatory network for each gene from the super-pathway network databases and represent it as a “tree” (FIG. 2). Subsequently, we extract a list of “regulatory ancestor genes,” referred to as regulators or regulatory genes, which collectively capture the impact of all nodes forming the regulatory tree. Some of the regulators are direct parents of the target gene and hence regulate its transcription directly, while the other regulators impact the target gene expression indirectly through protein complexes and post-translational modifications of direct regulators.

In developing a regulatory tree for each gene, we start with a specific target gene and traverse the upstream network in the opposite direction of links to collect all upstream nodes and capture the regulatory genes along with their depth, defined as the number of links to the root node, as depicted in FIG. 2, using a depth-first traversal algorithm, such as the well-known depth-first search (see pseudocode below), with some modifications based on the biology of gene transcription regulation and the fact that we are interested in predicting target gene expression using the expression of other genes that participate in the regulatory network.

We first terminate traversing a branch once we reach a predefined maximum depth level, where the depth is defined as the number of links from the visiting node to the root node. We then eliminate all the branches that do not terminate to a gene node; therefore, the leaves of tree are always genes. We pass through all nodes, except abstract nodes that represent the conceptual abstract processes, in order to avoid unnecessary network complications and inclusion of irrelevant interactions. While reaching a gene node, we only pass through the links that are not of type “transcription,” because the part of the upstream regulatory network which terminates to a gene node via a “transcription” link, is already accounted for by considering the expression level of this particular gene. The only exception for this rule is the root node, where we do the exact reverse as follows:

Passing from the root node to the direct neighbors in the first ring of root neighborhood is only allowed if the connecting edge is of “transcription” type to limit the parents to those who impact the expression level of the gene residing in the tree root. We also keep track of the distances from the leaves to the root node that is further used in the function learning process. Finally, if we meet a node via two disjoint paths, the shortest path is considered. The pseudo-code for the Module 1 selection process is summarized below, and a sample upstream tree extracted for gene PPP3CA from the network is depicted in FIG. 2.

Module 1: Building Regulatory Network for Each Gene using Modified Depth First Traverse Algorithm
Inputs: Pathway network, gene id: (g), maxDepth
Output: Regulatory Ancestor Gene Set, Depth Information

```
1 Set root node to input gene (r = g)
2 Set visit node to input gene (v = g), Set depth = 1;
3 Initialize visit_list, depth_list, connType_list and ancestor_list to empty sets.
4 Visit node (v, depth)
  a. If node v is in the visit_list and depth < depth_list(v)
    i. Update depth_list(v)=depth
    ii. return success
  b. If node v is in the visit_list and depth >= depth_list(v)
    i. Avoid this node
    ii. return fail (already visited via a shorter path)
  c. If node v is not in the visit_list
    i. Add v to visit_list
    ii. set depth_list(v) = depth
    iii. return success
5 If Visit node return fails [node is already visited], exit
6 If node v is a gene
  a. Add v to the ancestor list (g, depth, ancestor list)
    i. If node v is in the ancestor_list and depth < depth_list(v)
      1. Update depth_list(v)=depth
    ii. If node v is in the ancestor_list and depth >= depth_list(v)
      1. Avoid this node (already visited via shorter path)
    iii. If node v is not in the ancestor_list
      1. Add v to ancestor_list
      2. set depth_list(v) = depth
7 If depth < maxDepth [pass through this node to the next level]
  a. depth = depth+1;
  b. If node v is the root node (v==r)
    i. Remove the direct parents not connected via edges of type “transcription”
  c. If node v is of type gene and is not the root node (v<>r)
    i. Remove the direct parents connected via edges of type “transcription”
  d. for all nodes u in the parent list of the node v
    i. Goto step 4, call Visit node(u)
  e. depth = depth − 1; [returns to the previous level]
8 End
```

FIG. 2 is an example of a regulatory tree generated using the regulatory interactions derived from pathway databases for a sample gene PPP3CA. The subnetwork includes ancestor genes with depth 1 up to the 3rd level. Shapes define the node types with genes (ovals), protein complexes (rectangles), gene families (pentagon), abstract concepts (diamonds). The edges are colored according to their regulatory function with positive activation (yellow), negative activation (red), positive transcription (green), negative transcriptional (blue), component of protein complex (black) and gene family member (grey). The root node's epigenetic and sCNA measurements (rounded rectangles), considered as additional regulatory parents, are connected by green arrows. The regulators are collected up to level three (dₘₐₓ=3). The first level ancestors (direct parents) of the root node PPP3CA are shown to be connected via “transcription” edges that regulate the gene expression level. For instance, the complex CAM/Ca++ is connected to the root node via an activation link, and hence does not regulate gene expression level. Therefore, all the genes connecting via complex CAM/Ca++ in the left side of FIG. 2 are excluded from the final ancestor list. While passing through other genes, only non-transcriptional links are allowed. For instance, the upstream subnetwork of MYB is limited to the non-transcriptional nodes such as PIAS3 and MAP3K7 genes, whose impact is not already captured via the MYB expression level. The impact of genes GATA3 and E2F1 is implicitly accounted for by the expression level of gene MYB.

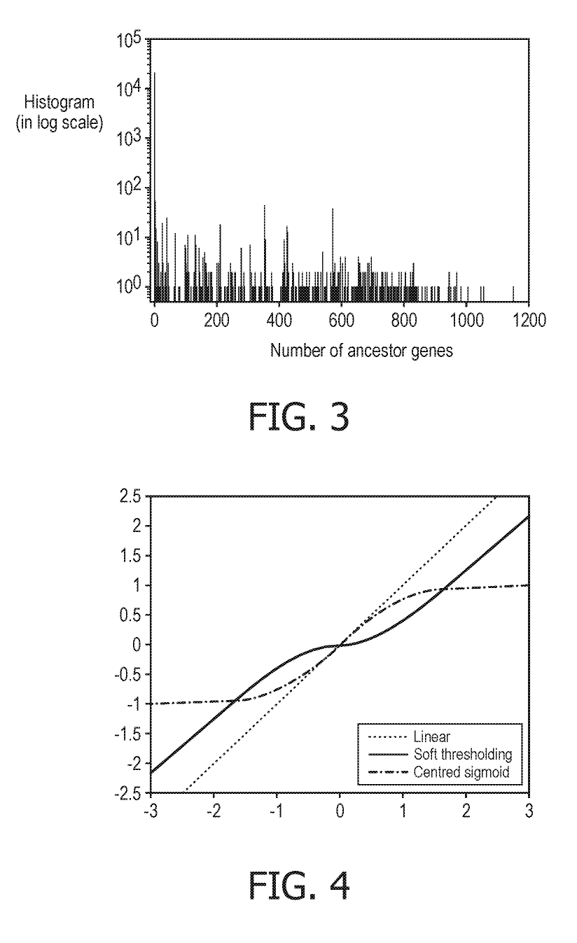

As an example, in FIG. 3 the empirical distribution of the number of ancestors when traversing up to 7 links upstream of the root node is presented in a logarithmic scale. A large number of genes are upstream isolated orphan genes. Only 839 genes have ancestors ranging from only one ancestor for 23 genes up to 1152 ancestors for gene CDKN1A. Genes with zero ancestors were not represented in the pathway network.

Module 2: Learning a Nonlinear Function for Each Gene

A second step of the inventive method is to learn a function relating the expression level of the gene residing at root node to its regulatory network and its own epigenetic information (e.g., DNA methylation and CNV). “Learning” a function means quantifying the influence of a regulatory gene's expression level on the target gene's expression. Also, the within method trains a model for a target gene that assigns different coefficients for parent genes based on their pairwise influence as observed in training data (as described in the Bayesian model estimation below, specifically the methods to estimate β_{g}). Because multiple DNA methylation probes may overlap with a gene's coding or regulatory regions, this invention leverages methylation measurements by including several representative statistics such as minimum, maximum, and weighted mean value, where in calculating the weighted mean we exclude the regions with less than 10 probes for more accuracy. Thus, if gene g, overlaps with n_{g}^{m} regions, each having probe number p₁, p₂, . . . , pₙ_{_{g}}_{^{m}}; and corresponding methylation measurement of m₁, m₂, . . . , mₙ_{_{g}}_{^{m}}, then the weighted mean is calculated as;

$${\tilde{m}}_{ℊ} = \frac{{Σ}_{i = 1}^{{n}_{ℊ}^{m}} {p}_{i} {m}_{i} I ( {p}_{i} \geq 10 )}{{Σ}_{i = 1}^{{n}_{ℊ}^{m}} {p}_{i} I ( {p}_{i} \geq 10 )} ,$$

where I(.) is the identity function.

To include copy number variations, this invention uses the segment mean value provided for the region that harbors the particular gene. Most genes fall into a single CNV segment. Otherwise, if a gene falls in the border of two segments, we simply take the mean value of both segment measurements.

In order to learn a function for each gene, Module 2 uses mRNA expression of its ancestors, somatic copy-number alteration and DNA methylation measurements for n_{g} samples to form the following classical regression model:

y_{g}=μ_{g}1ₙ_{_{g}}+X_{g}β_{g}+ϵ,ϵ˜ [symbol] (0,σ_{g}²Iₙ_{_{g}})

where y_{g} is a n×1 vector of expression levels for gene g across all n_{g} samples. X_{g}=[X_{g}^{(Self)},X_{g}^{(Parent)}] is a n×p data matrix composed of two parts including X_{g}^{(Self)} (self-methylation and CNV data) and X_{g}^{(Parent)} (the expression levels of the ancestor genes), where;

$${X}_{ℊ} = {[ {X}_{ℊ}^{( Self )} {X}_{ℊ}^{( Parent )} ]}_{n \times {p}_{ℊ}} , {X}_{ℊ}^{( Self )} = {[ \begin{matrix}{m}_{ℊ}^{1 ( min )} & {m}_{ℊ}^{1 ( max )} & {m}_{ℊ}^{1 ( mean )} & {c}_{ℊ}^{1} \\ … & … & … & … \\ {m}_{ℊ}^{n ( min )} & {m}_{ℊ}^{n ( max )} & {m}_{ℊ}^{n ( mean )} & {c}_{ℊ}^{n}\end{matrix} ]}_{n \times 4} , {X}_{ℊ}^{( Parent )} = {[ \begin{matrix}{x}_{1}^{1} & ⋯ & {x}_{{p}_{ℊ}^{′}}^{1} \\ ⋮ & ⋱ & ⋮ \\ {x}_{1}^{n} & ⋯ & {x}_{{p}_{ℊ}^{′}}^{n}\end{matrix} ]}_{n \times {p}_{ℊ}} , {y}_{ℊ} = [ \begin{matrix}{y}_{ℊ}^{1} \\ … \\ {y}_{ℊ}^{n}\end{matrix} ] , {p}_{ℊ} = {p}_{ℊ}^{′} + 4$$

The term 1ₙ_{_{g}} is all one column vector of length n_{g} and E is the model noise with i.i.d zero-mean unit-variance Gaussian elements. μ_{g} is the expected value of gene g expression level.

The objective here is to find the optimal model parameters βᵢ, i=1, 2, . . . , p that provides the best prediction power via minimizing the Mean Squared Error (MSE). One may use normal samples in learning phase to avoid model crash due to severely perturbed interactions in the highly contaminated/disordered cancer cells. However, this may lead to a poor predictive power when the number of predictors is large or comparable with respect to the number of samples (n<O(p)). In most studies, the number of cancer samples profiled tend to be significantly higher than the number of normal samples. For instance, in the case of TCGA data for breast cancer, the number of cancer samples exceed the normal samples by a factor of 10. Consequently, excluding all cancer samples is highly inefficient. On the other hand, including cancer samples in the training set, may deteriorate the model performance for specific genes that significantly deviate from the true underlying biological function in some samples due to genomic events as stated above. Therefore, we include all the normal samples and part of the cancer samples that have not impacted by somatic mutations in this particular gene and its ancestors in order to learn the predictive function. This approach leads to a different training set size for each gene, but provides a considerable improvement in model prediction power.

The Least Squared Error (LSE) solution minimizes the squared error for the training set, when no prior information is available about the model parameters βᵢ.

$$β = {{argmin}_{β} ( y - X β )}^{T} ( y - X β ) ⇒ {β}_{LSE} = {( {X}^{T} X )}^{- 1} {X}^{T} y$$

The LSE solution is not optimal when there is prior information about the model parameters. Here, there is prior knowledge about the model that can be used to enhance the model accuracy. First, it is likely that not all of the ancestor genes may have a substantial impact of a given gene's expression levels. Therefore, a significant number of the model parameters βᵢ could be shrunk towards zero. Therefore, imposing sparsity enhances the model generalization property by avoiding noise over-fitting. Although part of sparsity is already accounted for by using the pathway network and including only ancestor genes instead of using all genes as the input data; but a still higher level of sparsity is expected, when the number of ancestor genes grow higher (in order of tens and hundreds).

One of the common optimization-based solutions to impose sparsity is regularizing the norm of model parameters. The penalization can be applied to the Lₚ, p≥0 norm of coefficient vector β=[β₁, β₂, . . . , βₚ]^{T}, which is called bridge regression. Important special cases of this approach are Lasso, Ridge, and subset selection for L, L₂, L₀ norm penalization, respectively. In elastic net, the penalty term is the linear combination of L₁ and L₂ penalty;

$${β}_{L} = {{argmin}_{β} ( y - X β )}^{T} ( y - X β ) + {λ}_{1} {\vert β \vert}_{1} + {λ}_{2} {\vert β \vert}_{2} ,$$

where λ₁ and λ₂ are shrinkage parameters to impose sparsity and generalizability. Efficient algorithms based on convex optimizations, Basis pursuit, LARS, coordinate descent, Dantzig Selector, Orthogonal matching pursuit, and approximate message passing may be used to solve this problem. However, the most limiting drawback of these methods is that it only provides point estimates for the regression coefficients.

In contrast, this invention employs a Bayesian framework that provides more detailed information about the model parameters through posterior distribution to be used in the subsequent consistency check analysis. It also allows the incorporation of other prior knowledge, in addition to sparsity, as explained below.

Historically, in analyzing gene expression studies potentially non-linear relations among the biological measurements have been ignored. In order to capture such nonlinear relationships, Module 2 of this invention uses a centered sigmoid function

$${f}_{1} ( x ; c ) = \frac{1 - {e}^{- \frac{x}{c}}}{1 + {e}^{- \frac{x}{c}}}$$

to capture the sensitivity around the mean value and the soft thresholding function ƒ₂(x; c)=sign(x)(\sqrt{x²+c²}−c), to account for the cases in which only extremely high or low values contribute to the model. ƒ₂ (x; c) can be considered as a softer version of the commonly used peace-wise linear soft-thresholding function, ƒ(x; c)=sign(x)(|x|−c)₊. These functions are depicted in FIG. 4 compared to the linear function. We have applied the element-wise non-linear extension X_{g}→Ψ(X_{g})=[X_{g}^{s}, ƒ₁₍ₓ_{_{g}}_{^{s}}₎,ƒ₂₍ₓ_{_{g}}_{^{s}}₎, X_{g}^{p}] only to the self data (e.g., Methylation and CNV data), hence the number of predictors increases slightly compared to the number of ancestors for each gene. It is notable, that if the actual underlying function is linear, the coefficients of the nonlinear terms tend to zero in the proposed model, hence no performance degradation is observed while learning a nonlinear function for true linear relations.

Another important biological consideration in developing the ancestor-set for each gene through upwards traversing the pathway network is the variation in the distance of leaf nodes to the root node. One may expect the closer ancestors contribute more to the descendant downstream gene expression level than farther nodes that are connected via a long chain of intermediate nodes. Hence, the closer nodes tend to pose higher coefficient in the regression model. Module 2 leverages this fact into the method through depth penalization mechanism in the Bayesian framework, as captured by Id in the Bayesian model described below.

Here, this invention uses the Bayesian framework to predict the gene expression level via a nonlinear transformation/projection of its self-epigenetic data as well as the expression levels of the its regulatory ancestor genes. The Bayesian framework provides the desired statistics (e.g., median, mean, moments and . . . ) via full posterior distributions of the model parameters. Moreover, we incorporate a prior knowledge about the model parameters using hierarchical Bayesian models. The resulting posterior distributions provide significant insights into the functional effects of aberrations in the pathway.

The invention uses the idea of global and local shrinkages with penalization based on the distance of the ancestor gene (i.e., the number of links from leaves to root in the regulatory network) from the gene whose expression is being predicted. The following model is constructed, where the subscript g is omitted for notation convenience:

$$X -> Ψ ( X )$$

$$y \vert X , K , β , {σ}^{2} \sim N ( Ψ ( X ) β , {σ}^{2} {I}_{n} ) , K = diag ( [ {k}_{1}^{2} , … , {k}_{p}^{2} ] )$$

$$β \vert {σ}^{2} , {τ}_{1}^{2} , … , {τ}_{p}^{2} \sim {N}_{p} ( {0}_{p} , {σ}^{2} {D}_{τ} {K}^{- 1} ) {D}_{τ} = diag ( {τ}_{1}^{2} , … , {τ}_{p}^{2} ) \\ {k}_{1}^{2} , {k}_{2}^{2} , … , {k}_{p}^{2} \sim {\prod }_{j = 1}^{p} \frac{{( {a}_{k} / {d}_{j}^{2} )}^{a}}{Γ ( {a}_{k} )} {k}_{j}^{2 ( {a}_{k} - 1 )} {e}^{- {a}_{k} {k}_{j}^{2} / {d}_{j}^{2}}$$

$${k}_{j}^{2} \sim Gamma ( {a}_{k} , {a}_{k} / {d}_{j}^{2} ) j = 1 , 2 , 3 , …$$

$${τ}_{1}^{2} , … , {τ}_{p}^{2} \sim {\prod }_{j = 1}^{p} \frac{{λ}^{2}}{2} {e}^{- {λ}^{2} {r}_{j}^{2} / 2} ( {τ}_{j}^{2} \sim Expo ( {λ}^{′} = {λ}^{2} / 2 , {μ}^{′} = 2 / {λ}^{2} ) \\ π ( {σ}^{2} ) = \frac{{b}^{a}}{Γ ( a )} {( {σ}^{2} )}^{- a - 1} {e}^{- b / {σ}^{2}} = InvGamma ( {a}_{{σ}^{2}} > 0 , {b}_{{a}^{2}} > 0 ) d {σ}^{2}$$

The above formulation extends the normal gamma prior construction in order to incorporate the link depth information to the gamma prior construction. This information is leveraged via coefficients k included in the variance of the model parameters. Thus, the variance of βᵢ is chosen to be inversely proportional to the link depth of the corresponding ancestor via setting var(βᵢ)=σ²τᵢ²/kᵢ², where σ² controls the global shrinkage, τᵢ² accounts for the local shrinkage and Id enforces the link depth impact. To provide more flexibility, we Use of a Gamma prior distribution for kᵢ² provides more flexibility. Using gamma prior has the advantage of yielding closed-form posterior distribution for kᵢ and hence facilitates employing computationally efficient Gibbs sampler. Therefore, we use kᵢ²˜Gamma(aₖ, bₖ) such that the mean of variance is inversely proportional to depth parameter, i.e.,

$$E [ {k}_{i}^{2} ] = \frac{{a}_{{k}_{i}}}{{b}_{{k}_{i}}} = {d}_{i}^{2} c .$$

The constant c is a normalizing term to ensure

$$\frac{1}{p} {\vert K \vert}_{1} = 1 ,$$

which is obtained by setting

$$c = \frac{p}{{\sum }_{i = 1}^{p} {d}_{i}^{2}} .$$

Therefore, we only have one free hyperparameter aₖ_{ᵢ} for kᵢ prior distribution and the second parameter bₖ _{ᵢ} is automatically obtained from bₖ_{ᵢ}=aₖ_{ᵢ}/cdᵢ². We note that var(kᵢ)=aₖ_{ᵢ}/bₖ_{ᵢ}_{²}=c²dᵢ⁴/aₖ_{ᵢ}. Setting aₖ_{ᵢ} to small values provides higher variance for kᵢ and hence is less formative, while large values of aₖ_{ᵢ} provide low variance reflecting a high certainty about the network topology and the fact that node pairs with shorter paths are associated with higher influences to one another. In this case, the gamma distribution approaches a Gaussian distribution concentrated around dᵢ. We chose the relatively large value of a=aₖ_{ᵢ}=cdᵢ²bₖ_{ᵢ}=10 to highlight the significance of the underlying biological network.

The above hierarchical model yields the following full joint distribution:

$$p ( y , X , K , β , {σ}^{2} ) = p ( y \vert X , K , β , {σ}^{2} ) π ( β \vert {σ}^{2} , {τ}_{1}^{2} , … , {τ}_{p}^{2} ) π ( {k}_{1} , … , {k}_{p} ) π ( {τ}_{1}^{2} , … , {τ}_{p}^{2} ) π ( {σ}^{2} ) = \frac{1}{{( 2 {πσ}^{2} )}^{n / 2}} {e}^{- \frac{1}{2 {σ}^{2}} {( y - X β )}^{T} ( y - X β )} {\prod }_{j = 1}^{p} \frac{{( {a}_{k} / {d}_{j}^{2} )}^{a}}{Γ ( {a}_{k} )} {k}_{j}^{2 ( {a}_{k} - 1 )} {e}^{- {a}_{k} {k}_{j}^{2} / {d}_{j}^{2}}$$

$${\prod }_{j = 1}^{p} \frac{1}{\sqrt{2 {πσ}^{2} {τ}_{j}^{2} / {k}_{j}^{2}}} {e}^{- \frac{{β}_{j}^{2} {k}_{j}^{2}}{2 {σ}^{2} {τ}_{j}^{2}}} … {\prod }_{j = 1}^{p} \frac{{λ}^{2}}{2} {e}^{- {λ}^{2} {τ}_{j}^{2} / 2} \frac{{b}^{a}}{Γ ( a )} {( {σ}^{2} )}^{- a - 1} {e}^{- b / {σ}^{2}} ,$$

which immediately provides the following posterior distributions using the fact that the full conditional posterior distribution for each parameter is simply the product of the terms including that variable with other terms serving as a normalization constant to ensure the resulting probability integrates to one. This method is called completion of terms:

$$β \vert μ , Ψ ( X ) , y , {σ}^{2} , {τ}_{1}^{2} , … , {τ}_{p}^{2} \sim {N}_{p} ( {A}^{- 1} {Ψ ( X )}^{T} \tilde{y} , {σ}^{2} {A}^{- 1} ) , \\ A = {Ψ ( X )}^{T} Ψ ( X ) + {KD}_{τ}^{- 1}$$

$${γ}_{j} = 1 / {r}_{j}^{2} \vert μ , Ψ ( X ) , y , β , {σ}^{2} \sim inverse Gaussian ( \frac{λσ}{\vert {β}_{j} \vert} , {λ}^{2} ) I ( {γ}_{j} > 0 ) , \\ {σ}^{2} \vert μ , β , Ψ ( X ) , y , {τ}_{1}^{2} , … , {τ}_{p}^{2} \sim inverse Gamma ( a + \frac{n + p}{2} , \\ b + \frac{1}{2} {( \overline{y} - Ψ ( X ) β )}^{T} ( \hat{y} - Ψ ( X ) β ) + \frac{1}{2} {β}^{T} {D}_{τ}^{- 1} K β )$$

$${k}_{j}^{2} \vert μ , β , Ψ ( X ) , y , {σ}^{2} , {τ}_{1}^{2} , … , {τ}_{p}^{2} \sim Gamma ( {a}_{k} + \frac{1}{2} , \frac{{a}_{k}}{{d}_{j}^{2}} + \frac{{β}_{j}^{2}}{2 {σ}^{2} {τ}_{j}^{2}} )$$

The Woodbury Matrix inversion formula is used to calculate A⁻¹ when n<p to obtain more stable results and save in computations by converting a p×p square matrix inversion to a n×n one. We apply a Gibbs sampler with burn-in iterations 1000 and computation iterations 5000 to obtain the approximate posterior distributions for the model parameters βᵢ, σ. This process is repeated for all genes g∈G using all samples s∈S, where G and S are the set of gene ids and sample ids, respectively.

### Module 3: Predict Gene Level Expression for a New Sample and Report Activation and Consistency Level for all Genes

In order to evaluate the disruption of a target gene g for any given sample, we obtain activation score A_{g}^{(new)} and inconsistency score C_{g}^{(new)}, where the first shows the level of gene expression, which may be consistent with its regulatory network, and the second shows the deviation from the expected value pointing to deregulation of the gene (potentially associated with somatic mutations).

Performing Module 2 using training samples from both normal and cancer cohorts provides results in the form of a function bank, where each function corresponds to a specific gene. This function bank is then used in Module 3 to analyze test samples to identify potential inconsistencies. Thus, this module performs gene expression level prediction for all genes. For each gene, we extract the expression levels of the ancestor genes as well as the self-epigenetic information for all samples. Then, we predict expression level of this specific gene for all samples using the corresponding function learned for this gene. The prediction process provides the conditional posterior distribution for the expression level of this gene. We use the maximum a-posteriori (MAP) method to obtain the expected gene expression levels.

In order to calculate consistency scores for un-isolated target genes for which a function is learned, we note that the predictive distribution for the RNA expression of any gene for each new test sample y^{new} is obtained by marginalizing out the model parameters from the conditional posterior distribution for given input x^{new} (self-epigenetic info and ancestors expression levels):

ƒ(y^{new}|x^{new})=∫ƒ(y^{new}|x^{new},β,σ²)ƒ(β,σ²|y,X)dβdσ²

While the first term, which is the conditional distribution, is available in-closed form, the second term which is the posterior distribution of model parameters is not. This distribution can be approximated with the following expression, where the realizations of model parameters (β⁽ⁱ⁾, σ²^{⁽ⁱ⁾}) are obtained using Gibbs sampling method.

$$f ( {y}^{new} \vert {x}^{new} ) ≅ \frac{1}{N} {\sum }_{i = 1}^{N} f ( {y}^{new} \vert {x}^{new} , {β}^{( i )} , {σ}^{2 ( i )} )$$

The above distribution is a Gaussian mixture model (GMM) with large number of equi-probable components of mean (Ψ(x^{new})^{T}β⁽ⁱ⁾) and variance (σ²^{⁽ⁱ⁾}). If the Gibbs sampler converges, β⁽ⁱ⁾ is concentrated around β_{MAP} with covariance matrix Σ_{β}=diag([σ_{β}_{₁}_{²},σ_{β}_{ₚ}_{²}]), where the entities σ_{β}_{ᵢ}_{²} are small compared to σ²^{⁽ⁱ⁾}. Therefore, Ψ(x^{new})β⁽ⁱ⁾ approaches a normal distribution for large number of predictors regardless of βᵢ distribution according to central limit theorem. In order to save in computations and storage, we use the following Normal distribution as a surrogate for the predictive distribution:

ƒ(y^{new}|x^{new})=N(y^{new};μ_{y}_{^{new}}_{|x}_{^{new}},σ_{y}_{^{new}}_{|x}_{^{new}})

μ_{y}_{^{new}}_{|x}_{^{new}}=Ψ(x^{new})^{T}β_{MAP},σ_{y}_{^{new}}_{|x}_{^{new}}²=∥Ψ(x^{new})^{T}Σ_{β}∥₂²+σ_{MAP}²)

where ∥.∥₂ is the matrix induced norm. Based on this distribution, we calculate the z-score or the equivalent likelihood for the observed value as follows:

$${z}_{c}^{new} = \frac{{y}^{new} - {Φ ( {x}^{new} )}^{T} {β}_{MAP}}{{σ}_{{y}^{new} \vert {x}^{new}}} , \\ {L}_{c}^{new} = log f ( {y}^{new} \vert {x}^{new} ) = const - log ( {σ}_{{y}^{new} \vert {x}^{new}} ) - .5 {( {z}_{c}^{new} )}^{2}$$

Moreover, due to the complexity of the underlying biological process for each gene and different level of inherit randomness, natural regularity and impact of unknown factors, the predictive power of the learned functions maybe significantly different for each gene. Accordingly, we consider the average empirical predictability of each gene for normal samples as a ground level for the consistency check. Hence, only cancer samples having consistency levels far below the average inconsistency of normal samples are reported as inconsistent samples. The following normalized likelihood is used:

$${LN}_{c}^{new} = log ( \frac{f ( {y}^{new} \vert {x}^{new} )}{{( \sqrt[{n}_{0}]{{\prod }_{i = 1}^{{n}_{0}} f ( {y}_{i} \vert {x}_{i} )} )}^{1 - α} {( \sqrt[{n}_{1}]{{\prod }_{i = 1}^{{n}_{1}} f ( {y}_{i} \vert {x}_{i} )} )}^{α}} ) \approx cnst + {L}_{c}^{new} - \frac{1 - α}{{n}_{0}} {\sum }_{i = 1}^{{n}_{0}} {L}_{c}^{i} - \frac{α}{{n}_{1}} {\sum }_{i = 1}^{{n}_{1}} {L}_{c}^{i} ;$$

where n₀ and n₁ are the number of normal and cancer samples and a is a tuning parameter between 0 and 1 in order to push different emphasis on normal and cancer cohorts. Lower values for α are chosen in order to emphasis more on the normal cancers and compensate for the lower number of normal samples. In this invention, we arbitrarily set α= 1/10, which is almost equal to the ratio of normal samples to cancer samples in the training set for TCGA Breast Cancer dataset. The inequality becomes equality if the variances of the predictive distribution are equal for all samples. The above process is repeated for all genes in parallel.

In addition to consistency score, the activation score of each gene is obtained using the gene expression level distribution modeled as a normal distribution;

$$y \sim N ( μ , {σ}^{2} ) ⇒ {z}_{A}^{new} = \frac{{y}^{new} - μ}{σ} , {L}_{A}^{new} = log f ( {y}^{new} ; μ , {σ}^{2} ) = const - log ( σ ) - 0.5 {( {z}_{A}^{new} )}^{2} ,$$

where μ and σ is the mean and standard deviation of the normal distribution learned for each gene expression level after iteratively excluding the outliers. The postscript g is omitted for notation convenience. A similar normalization is used for activation scores.

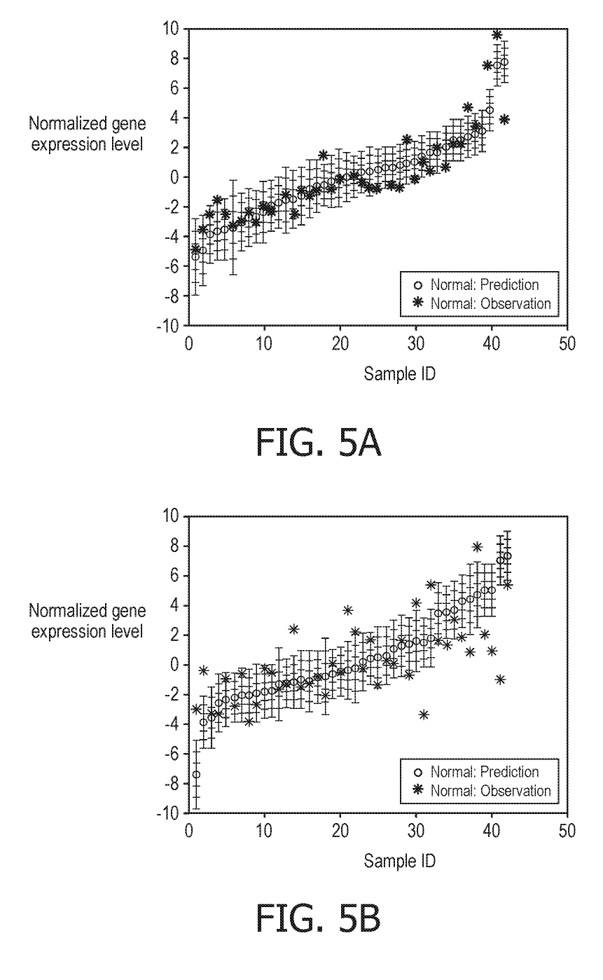

As discussed above, the application of this module is to use the trained model on top of the regulatory network to predict a desired target gene expression level for a given sample based on the target gene epigenetics as well as expression levels of the genes playing transcription regulations roles in the utilized regulatory tree. In FIG. 5, an illustrative example is shown to predict the gene JUN expression level across test samples including 42 normal and 42 tumor samples derived from the TCGA colon cancer dataset. The model is trained using 338 normal and 368 cancer samples with 5-fold cross validation, using Module 1 and 2. The gene JUN has 51 upstream regulators up to level 2 in the employed pathway network, as derived using Module 1. In FIG. 5, the predicted values along with the standard deviation around the posterior mean are shown for both normal and tumor samples, as obtained by employed the model learned in Module 2 within Module 3. Presentation of confidence interval shown in this figure is an advantage of the inventive method in predicting the gene expression level compared to the point-estimate methods where only the predicted values are obtained and no statistics about the confidence of prediction is provided. The second observation is that the gene JUN is tightly regulated across normal samples since its predicted value based on the expression level of its regulators is more accurate for normal samples as compared to cancer samples. In fact, only 5 normal samples experience JUN expression levels deviating beyond 3 standard deviations from the predicted value compared to 14 tumor samples with similar levels of deviation.

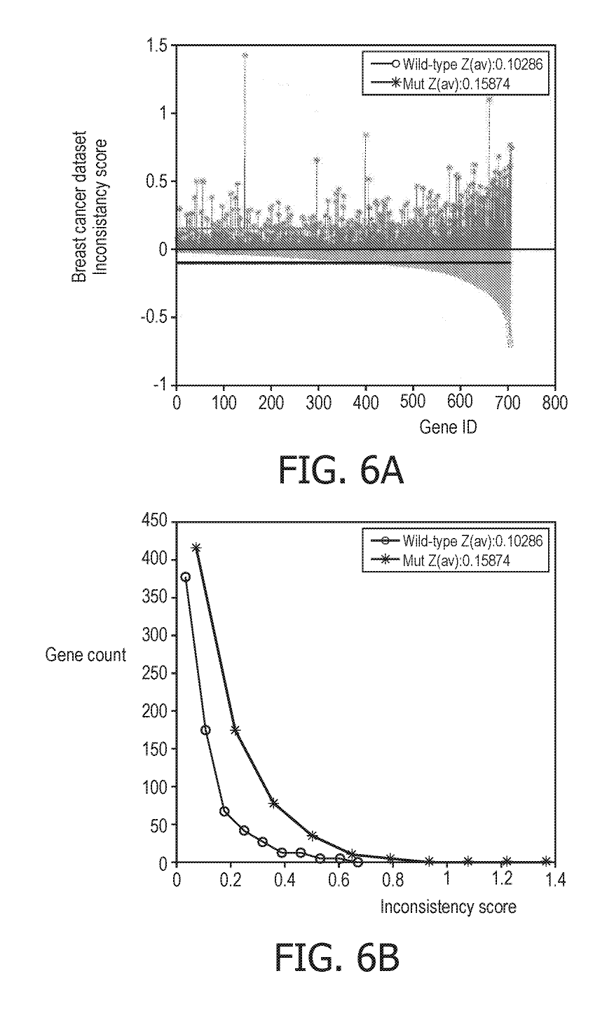

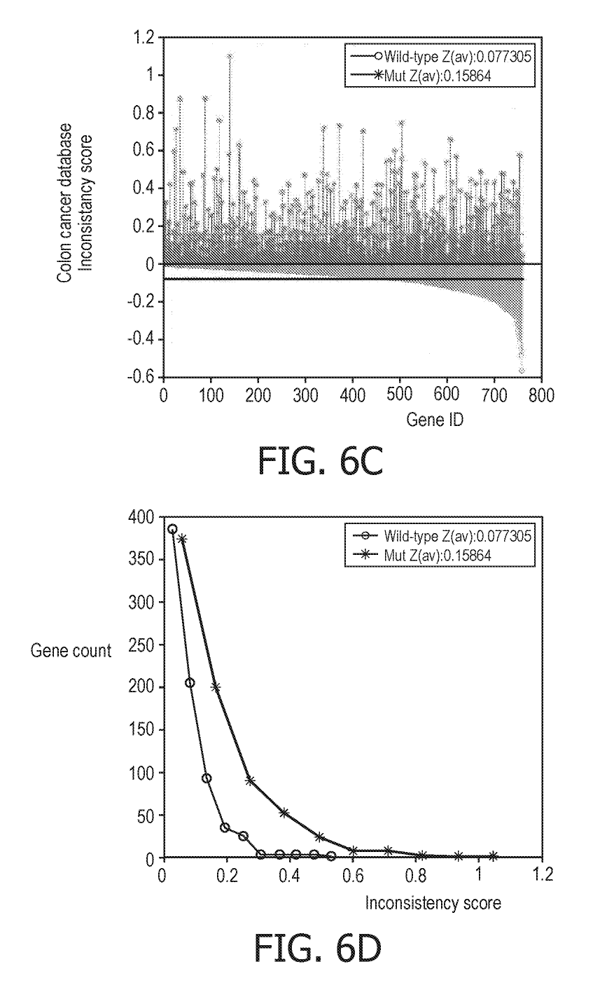

To further illustrate the association between the gene expression level inconsistencies with somatic mutations as established in this module, FIG. 6 provides a global statistical analysis for both BRCA and CRC across all genes for which a regulatory network is available. In this regard, for each gene, the tumor samples are divided into two subsets: i) where the gene of interest or some of its first and second level regulators are mutated; and ii) all regulators are wild type. Then, we take the average of absolute inconsistency levels for both mutated and non-mutated subsets (FIGS. 6A, 6C). The histogram of inconsistency scores for the two subsets (FIGS. 6B and 6D) reveals that the inconsistency scores for the mutated subset in both cancers are significantly higher than those of the non-mutated subset.

In FIGS. 6A and 6C, each stem corresponds to a specific gene, where the red stems are the average absolute inconsistencies for samples with mutations in that target gene or its regulatory network (up to level two), while the green stems are the negative of the average absolute consistency score across all samples where the gene of interest and its close parents are wild-type. The green stems for samples with wild-type regulatory genes are flipped vertically for ease of presentation. The genes are sorted based on their average inconsistency levels in wild-type samples. FIGS. 6B and 6D are the histogram obtained for average inconsistency scores. The top and bottom rows are respectively for breast and colorectal cancers. The results show a higher level of average inconsistencies across samples that the target gene or its close parents in the regulatory network harbor somatic mutations.

### Module 4: Association Between Somatic Mutations and Inconsistencies

Gene expression levels may deviate from predicted values by the presence of somatic mutations in the regulatory network, resulting in loss/gain of regulatory functions. That is, a mutation in any of regulator genes may impact its proper role in regulating gene expression and impose a deviation on the target gene expression. Module 4 of the within method provides a methodology which assesses the impact of somatic mutations in regulatory genes on the inconsistency scores for downstream target genes. Accordingly, this module takes the activation and consistency scores provided by Module 3 and, for each new test sample, identifies the genes that are significantly inconsistent and examines if they are potentially driven by CNV aberrations or somatic mutations in the current gene or in its regulatory subnetwork.

To begin, the inconsistencies driven by CNV aberration events are identified. If the inconsistency is due to overexpression of the gene and the gene experiences copy number amplifications (CNV>0.5), then CNV amplification is reported as the main cause of the inconsistency. Likewise, if copy number deletion (CNV<−0.5) is associated with the down expression of the gene, CNV deletion is considered to be the inconsistency driver.

For the genes which do not experience relevant copy number aberrations, the inconsistencies are likely to arise from mutations in the upstream regulatory network of the gene that impacts the transcription of the downstream gene. The closer the regulatory gene is to the downstream target gene, the more influence is expected on the downstream gene expression level inconsistency. Therefore, Module 4 assigns a global depth penalization parameter 0<α≤1, such that the impact of mutated gene i with d₁₉ hops to the root node g is scaled with value (α)^{d}^{_{ig}}. As →1, the impact of depth becomes less significant. We choose α=½ is the results section.

To quantify the impact of mutations in the regulatory tree, we count all non-silent mutations affecting either the target gene or its regulators for each of the cancer samples scaled by their absolute inconsistency levels and the depth penalization factor. In general, the functional impact of gene h mutations on the expression of gene g, denoted by ƒ_{g}(h) is calculated as:

$${f}_{g} ( h ) = \frac{{\sum }_{j = 1}^{n} 1 ( h ∈ {M}^{( j )} ⋂ {P}_{g} ) {( α )}^{{d}_{h , g}} \vert {z}_{c ( g )}^{( j )} \vert )}{{\sum }_{l ∈ {P}_{g}} {\sum }_{j = 1}^{n} 1 ( l ∈ {M}^{( j )} ⋂ {P}_{g} ) {( α )}^{{d}_{l , g}} \vert {z}_{c ( g )}^{( j )} \vert )}$$

where P_{g} is the set of regulatory ancestor genes of gene g (i.e., the leaves of the corresponding regulatory tree), M(i) is the set of genes that are mutated in sample j, Z_{c(g)}^{(j)} is the inconsistency score of gene g at sample j and 1(.) is the indicator function. The role of the denominator is to normalize Σ_{h∈P}_{_{g}}ƒ_{g(h)}=1. Therefore, ƒ_{g(h)} quantifies the relative impact of mutations in all genes belonging to the regulatory network h∈P_{g} on the target gene g.

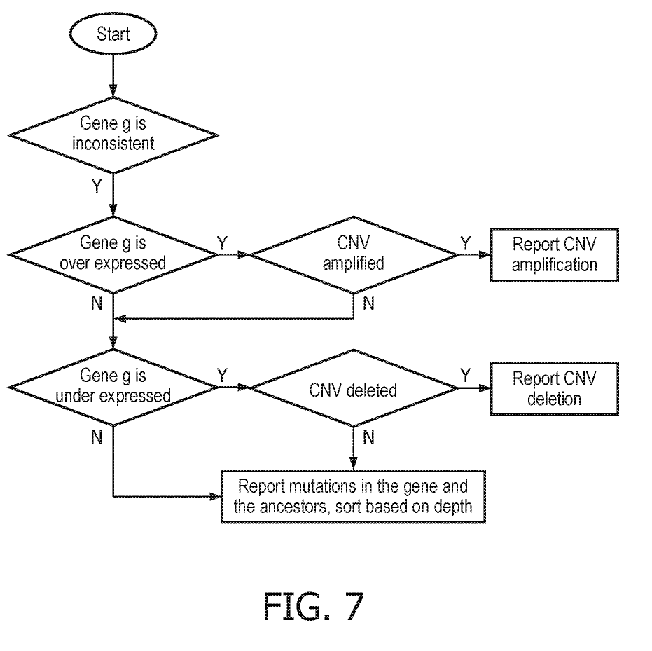

The flowchart in FIG. 7 summarizes the interpretation of per sample inconsistency in this method. Repeating this procedure for all samples, and sorting the genes based on their assigned somatic mutation impact profiles (ƒ_{g}(h), ∀g∈G, ∀h∈P_{g}) filters out the passenger events and determines the most influential parent genes whose mutations functionally impact the downstream transcription factor gene. Thus, the invention allows for the identification of functional mutations that impact downstream gene expression. Give the functional impact of the majority of observed missense mutations across disease contexts are largely unknown, this inventive step allows clinicians and/or researchers to focus in on the most likely functional disease-associated mutations in a given context, thus enabling the identification of novel biomarkers as well as potential therapeutic targets.

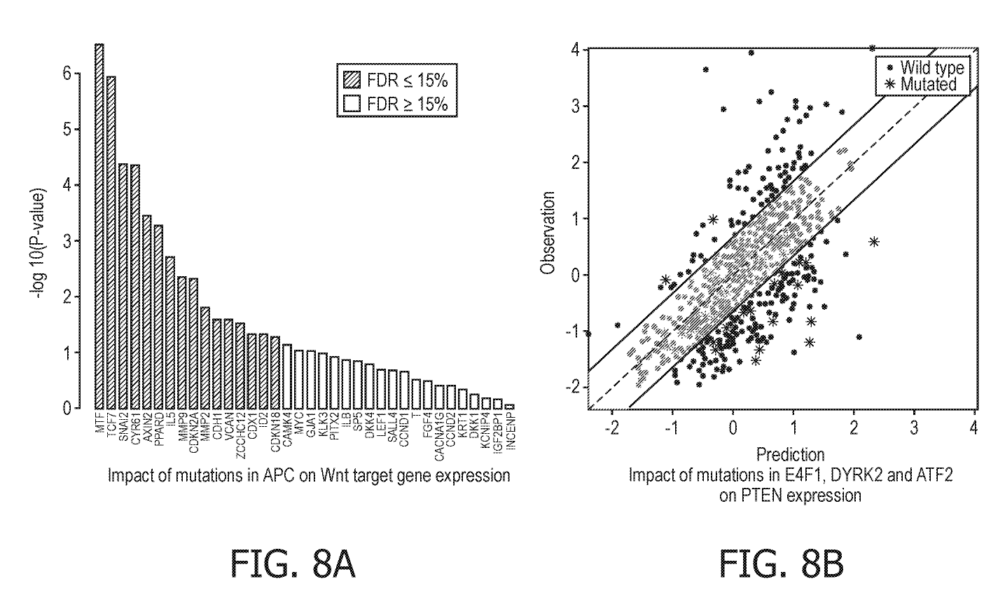

FIG. 8 is an example of the results generated in Module 4 illustrated in graphical form. Specifically, FIG. 8A displays the relative impact of somatic mutations in APC on Wnt pathway target gene expression for genes identified with colon cancer. Plotted are the −log 10(Pvalue) of the significance of association of target gene activation and inconsistency with the mutations affecting APC in colon cancer samples. Genes highlighted in green are significantly affected (FDR≤15%). In FIG. 8B, the impact of somatic mutations in the upstream regulatory subnetwork of PTEN on its gene expression inconsistency is displayed. Depth penalization parameter is set to α=½. The modulation effect of combinations of somatic mutations in parents of PTEN on its regulations are shown, where the mutations in gene set {PTEN, DYRK2, E4F1 and ATF2} show significant association with down-expression of PTEN. Therefore these genes modulate the impact of somatic mutations in PTEN. Thus, mutations in DYRK2, E4F1 and ATF2 jointly affect the expression of PTEN, so the combination of these mutations provides a more accurate functional status of PTEN in tumors. Given that the disruption of PTEN results in the oncogenic activation of the AKT pathway, mutations in these genes are prognostic and/or biomarkers for selection of therapies.

### EXAMPLES

In to illustrate the prediction power of the method of this invention, its performance is compared to several near-optimal state-of-the art point-estimators including LASSO, RIDGE and Elastic-Net Regressions.

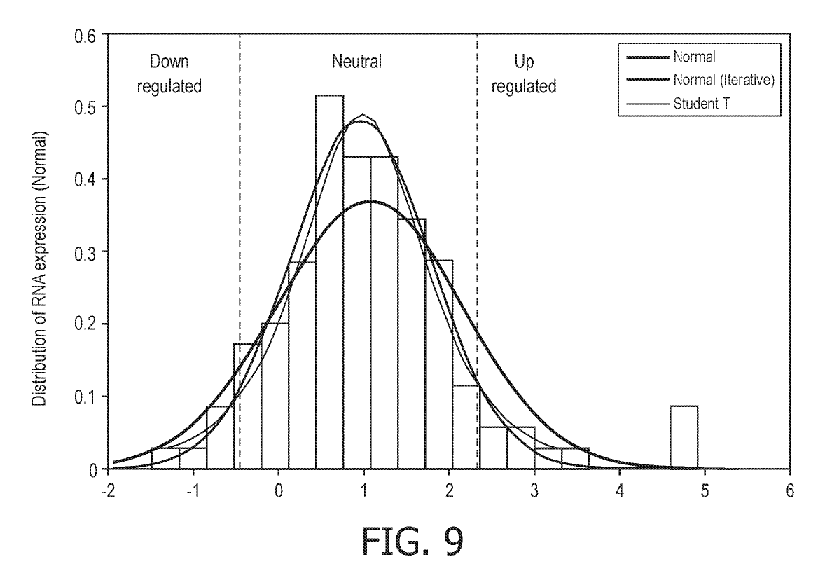

In order to demonstrate the accuracy of the inventive method, we first learn a Gaussian distribution for each gene expression level via maximum likelihood method after iteratively excluding significant outliers. We begin by learning a Gaussian distribution for the samples at each iteration and then we remove the samples which are not in the second standard deviation neighborhood of the mean value. In the subsequent iteration we repeat the process for the remaining samples until the algorithm converges and no more outlier exists. The empirical distribution for a sample gene PTEN and the learned Normal distribution is presented in FIG. 9. We also learn a Student t distribution for comparison purpose. Student −t distribution has the advantage of robustness to outliers and is very close to the normal distribution after outlier exclusion as shown in FIG. 9.

Next, we divide gene expression levels into three states (neutral, over-expressed and under-expressed) based on predefined thresholds. Thresholds are arbitrarily set such that the probability of down-expression, neutral and over-expression states become 10%, 80% and 10%, respectively. Module 3 provides patient-specific gene expression predictions for all 839 un-isolated genes. The state change rate is calculated via averaging state change events over all genes and patients. The results are calculated for each cohort separately. If the observed and predicted expression state for sample i and gene g are s_{g}⁽ⁱ⁾ and ŝ_{g}⁽ⁱ⁾, respectively, the state change rate is calculated as:

$$SER = \frac{1}{\vert G \vert \vert S \vert} {\sum }_{g = 1}^{\vert G \vert} {\sum }_{i = 1}^{\vert S \vert} I ( {s}_{g}^{( i )} \neq {\hat{s}}_{g}^{( i )} )$$

In Table 1, the prediction error is calculated for some important genes that are highly associated with cancer and have a valid set of upstream regulatory genes in the global pathway network. It is seen that the within method outperforms the state of the art sparsity-imposing regression models with the additional advantage of providing full posterior distribution for the gene expression level.

TABLE 1
Gene state prediction error rate for the within method in comparison with the benchmark
optimization-based sparse regression models. The model training and test is the same for all
methods. The prediction accuracy for normal and cancer samples are presented separately.

| | Number | Test Results on Normal Samples | | | | Test Results on Cancer Samples | | | |
|---|---|---|---|---|---|---|---|---|---|
| | of | | | Elastic | | | | Elastic | |
| Gene | Parents | Lasso | Ridge | Net | InFloMut | Lasso | Ridge | Net | InFloMut |
| CBFB | 57 | 0.1532 | 0.1622 | 0.1441 | 0.1622 | 0.1854 | 0.1909 | 0.1937 | 0.1881 |
| CCND1 | 836 | 0.2703 | 0.2883 | 0.2703 | 0.2432 | 0.2919 | 0.2947 | 0.2873 | 0.2614 |
| CDH1 | 159 | 0.1802 | 0.1261 | 0.1712 | 0.1622 | 0.2484 | 0.2391 | 0.2456 | 0.2428 |
| CDKN1B | 456 | 0.2162 | 0.1892 | 0.1982 | 0.1982 | 0.2994 | 0.2799 | 0.2780 | 0.2530 |
| CTCF | 417 | 0.1261 | 0.0901 | 0.1261 | 0.1171 | 0.1409 | 0.1353 | 0.1474 | 0.1325 |
| ERBB2 | 99 | 0.2252 | 0.2973 | 0.0811 | 0.2523 | 0.3883 | 0.4013 | 0.3818 | 0.3272 |
| FOXA1 | 206 | 0.1712 | 0.1441 | 0.2072 | 0.1261 | 0.1196 | 0.1242 | 0.1242 | 0.1177 |
| GATA3 | 223 | 0.3423 | 0.2703 | 0.3333 | 0.3423 | 0.1613 | 0.1529 | 0.1603 | 0.1585 |
| MYB | 219 | 0.0901 | 0.0811 | 0.0901 | 0.0901 | 0.1891 | 0.1752 | 0.1900 | 0.1891 |
| PTEN | 226 | 0.0541 | 0.0631 | 0.0721 | 0.0631 | 0.1631 | 0.1585 | 0.1696 | 0.1603 |
| RB1 | 342 | 0.0721 | 0.0811 | 0.0811 | 0.0901 | 0.1835 | 0.1854 | 0.1724 | 0.1696 |
| RUNX1 | 57 | 0.2162 | 0.2613 | 0.2432 | 0.1982 | 0.1965 | 0.1946 | 0.1993 | 0.1891 |
| TP53 | 325 | 0.2162 | 0.1441 | 0.2162 | 0.1171 | 0.3309 | 0.3216 | 0.3309 | 0.2956 |
| | | 0.1795 | 0.1691 | 0.1719 | 0.1663 | 0.2229 | 0.2195 | 0.2216 | 0.2065 |

Another important observation is that despite the fact of higher contribution of cancer samples to the model training due to the larger number of cancer samples with respect to normal samples, the normal cohort presents a better predictability. This observation holds for all models and reveals that the functional states of the gene expressions in normal tissues are more consistent with the upstream regulatory network.

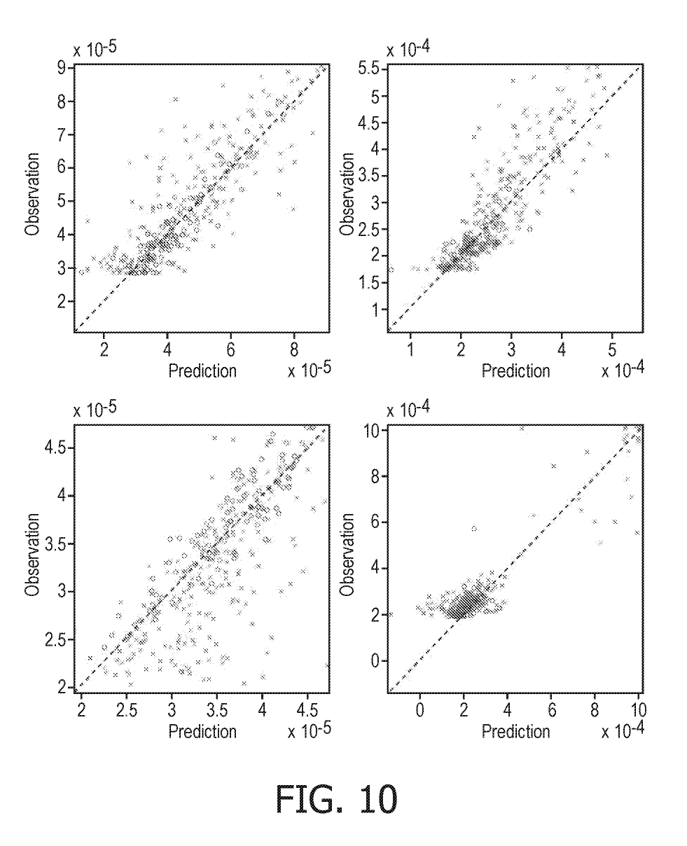

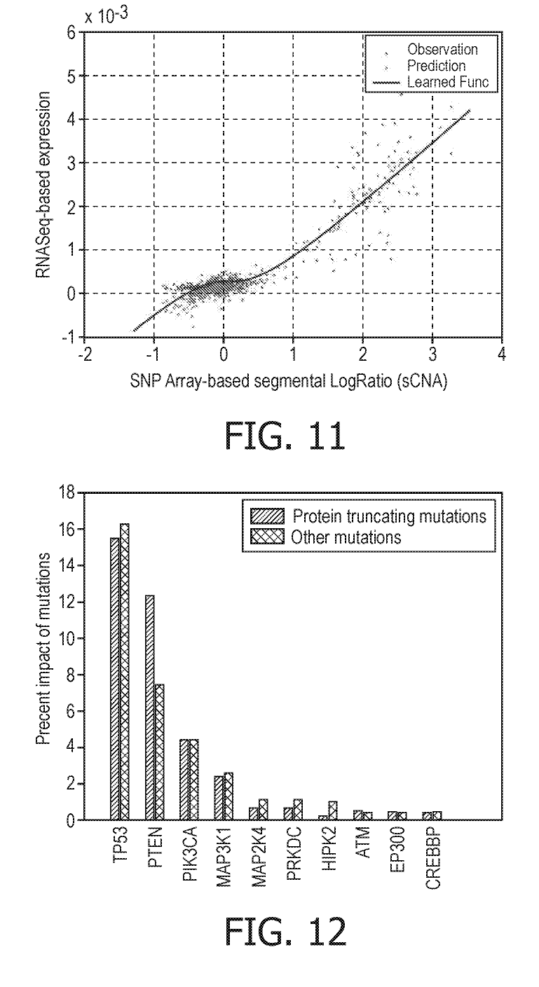

The fact of higher consistency between the predicted and observed values of target gene expression levels in normal samples compared to cancer samples is also observed in FIG. 10, where the observation and prediction values for sample genes MYB, GATA3, PTEN and ERBB2 are presented. Here, the gene expression levels in normal samples are more consistent with the predictions obtained from the gene self-epigenetic data and its upstream transcription regulation network. This figure shows the importance of inconsistency analysis for cancer samples which may arise from different sources and reveals additional information about the pathway perturbations and gene dysregulations with respect to the methods that only analyze the expression levels of genes. The inconsistency may arise due to various sources such as copy number amplification and deletion in the target gene as well as the mutations in the regulatory network that disrupts the normal behavior of the regulatory network role and consequently impacts the expression level of the target gene resides in the root of the regulatory network. In order to gain more insight about the model coefficients, the model parameters obtained for two genes ERBB2 and GATA3 are presented in Table 2 and Table 3. Each row presents the corresponding coefficient value obtained by different learning methods and for the within non-linear Bayesian method. The standard deviation for the posterior distribution is also presented in brackets in the last column. It is shown that the expression level of ERBB2 is highly dependent on copy number aberration events affecting its locus as seen in the model parameter of the proposed nonlinear soft-thresholding function. This nonlinearity reflects the ignorance of the model to small turbulences around zero which is likely measurement noise. Therefore, the copy-number associated log Ratio values derived from SNP-arrays can be used directly in the model without the need to discretize the log Ratios into amplified/neutral/deleted states. The relevance of the nonlinear function is interestingly picked up by all learning methods. FIG. 11 verifies this relevance, where the relation between the observed RNA as well as the predicted RNA versus CNV is depicted for gene ERBB2. In FIG. 11, the blue and red points correspond to the observations and the predictions obtained from the model. The black curve is the nonlinear RNA CNV relation obtained by the model parameters in Table 2.

This figure demonstrates that the nonlinear CNV terms with coefficients obtained from the learning process well define the RNA expression level for ERBB2 with some minor variability due to other terms such as DNA methylation and ancestor gene expression levels. In fact, the coefficients of DNA methylation and majority of ancestors are explicitly removed from the predictor list by LASSO and Elastic Net Methods and also notable is that the within invention assigns negligible coefficients for DNA methylation.

TABLE 2
Model parameters for two gene: ERBB2.

| | | | ELAS- | |
|---|---|---|---|---|
| Model Parameters for | | | TIC | InFlo-Mut [Std |
| (ERBB2) | LASSO | RIDGE | NET | Deviation] |
| Methylationₘᵢₙ | 0.0000 | −0.0057 | 0.0000 | −0.0015: [0.0120] |
| Methylationₘₐₓ | 0.0000 | −0.0185 | 0.0000 | −0.0027: [0.0134] |
| Methylationₘₑₐₙ | 0.0000 | −0.0215 | 0.0000 | −0.0152: [0.0355] |
| f₁ (Methylationₘₑₐₙ) | 0.0000 | 0.0530 | 0.0054 | 0.0220: [0.0247] |
| f₂ (Methylationₘₑₐₙ) | −0.0504 | −0.0734 | −0.0626 | −0.0588: [0.0319] |
| CNVₘₑₐₙ | 0.0000 | 0.3685 | 0.0181 | 0.0453: [0.0638] |
| f₁ (CNVₘₑₐₙ) | −0.0986 | −0.1579 | −0.1268 | −0.1457: [0.0376] |
| f₂ (CNVₘₑₐₙ) | 0.9958 | 0.6272 | 0.9951 | 0.9858: [0.0524] |
| \sqrt{Σ\|βᵢ\|²} for ancestors | 0.1232 | 0.2149 | 0.1528 | 0.1663 |

On the other hand, the RNA expression level for GATA3 is more influenced by DNA methylations as well as upstream regulatory network. The expected negative sign for DNA methylation coefficients are suggestive of an inverse relationship between the gene expression level and DNA methylation for both genes. Finally, for GATA3, the upstream regulatory network plays a crucial role in regulating the expression of this gene, suggesting that most of the variation of this gene's expression in breast cancer arises primarily due to the activity of transcription factors. The regression coefficients estimated by the method for two genes ERBB2 and GATA3 provided in Table 2 and 3 reveal that the regression coefficients can be significantly different for genes due to high heterogeneity of the gene regulation functionalities.

TABLE 3
Regression coefficients for gene GATA3.

| Model Parameters | | | ELASTIC | |
|---|---|---|---|---|
| for (GATA3) | LASSO | RIDGE | NET | InFlo-Mut |
| Methylationₘᵢₙ | 0.0000 | 0.0120 | 0.0000 | 0.0201 [0.0183] |
| Methylationₘₐₓ | −0.0842 | −0.0510 | −0.0838 | −0.0864 [0.0201] |
| Methylationₘₑₐₙ | 0.0000 | −0.0450 | −0.0142 | −0.0327 [0.0422] |
| f₁ (Methylationₘₑₐₙ) | −0.1888 | −0.0544 | −0.1667 | −0.1221 [0.0426] |
| f₂ (Methylationₘₑₐₙ) | 0.0000 | −0.0342 | 0.0000 | −0.0099 [0.0273] |
| CNVₘₑₐₙ | 0.0000 | −0.0009 | 0.0000 | 0.0068 [0.0270] |
| f₁ (CNVₘₑₐₙ) | 0.0000 | 0.0015 | 0.0000 | 0.0199 [0.0247] |
| f₂ (CNVₘₑₐₙ) | 0.0000 | −0.0033 | 0.0000 | 0.0003 [0.0232] |
| \sqrt{Σ\|βᵢ\|²} of ancestors | 0.3157 | 0.3329 | 0.3085 | 0.4903 |

An important source of inconsistency is due to mutations in the target gene's upstream regulatory network. Noting the fact that the impact of expression level of regulatory genes is already captured by the method if the predicted value of target gene expression level is not consistent with the observed value then we infer that the regulatory network does not play its regulatory role properly. This malfunction of the regulatory network most likely arises from somatic mutations in the regulatory network that prevents its genes or product proteins from performing their functions (complex formation, gene transcription, protein activation and . . . ) properly which in turn impacts the downstream target gene expression level.

As an illustrative example, the functional impact of somatic mutations on the dysregulation of gene PTEN is depicted in FIG. 12, revealing that the inconsistencies in PTEN expression are highly associated with mutations in TP53, PTEN, PIK3CA, MAP3K1 and MAP2K4. The higher impact of TP53 mutations versus PIK3CA is particularly interesting given that PIK3CA is mutated more often than TP53 (387 samples versus 333 samples respectively). We observe that MAP3K1 and MAP2K4 mutations, previously shown to be associated with luminal breast cancers, impact PTEN inactivation, thus providing an intriguing nexus between these genes in driving a key subtype of breast cancers. We also calculate the relative impact of protein-truncating and other non-synonymous mutations on the inconsistency score for PTEN. The model determines that the two kinds of mutations have similar impacts when they affect any of the regulatory genes of PTEN while the protein-truncating mutations in PTEN have a higher impact on its deregulation, consistent with nonsense-mediated decay of PTEN mRNA. Depth penalization parameter is set to α=½.

1. A method for identifying patient-specific somatic aberrations driving dysregulated genes, comprising the steps of:
determining a primary dataset of upstream regulatory parent gene information for each target gene by obtaining biological network pathway information;
determining a regulatory sub-network from said primary dataset for each of said target genes, the regulatory sub-network comprising a relationship between said target gene's expression level with said target gene's genomic and epigenetic status, and said gene's upstream transcriptional regulators;
determining a second dataset of measurement-based omics data comprising at least one of RNAseq expression data, copy number variation data, and DNA methylation data;
integrating said primary dataset and said second dataset;
generating a non-linear function for each of said target genes, said non-linear function relating said gene's expression level to measurements associated with the regulatory sub-network, from said integrated primary and second dataset;
calculating expected expression levels for each of said target genes using said non-linear function for said target gene;
determining a third dataset of patient-specific information relating to observed gene expression levels for said target genes and comprising a sequence of one or more parent genes in the determined regulatory sub-network of one or more of the target genes;
calculating patient-specific inconsistency scores between said expected gene expression levels and said observed patient-specific expression levels for each of said target genes;
calculating patient-specific activation scores for each of said target genes;
evaluating the activation and inconsistency scores for all patient samples to identify the patient-specific target genes whose expression levels are significantly inconsistent with said expected expression levels;
identifying statistically significant associations between inconsistencies in the target gene expression level with the somatic mutations in the upstream regulatory network of that particular target gene, comprising the step of calculating for each parent gene in the upstream regulatory network of the particular target gene for which a mutation has been identified, a functional impact score of a somatic mutation based at least in part on the calculated patient-specific inconsistency score, the genes in the upstream regulatory network of the particular target gene, and a set of genes comprising one or more mutations;
determining based on the calculated functional impact scores for two or more parent gene in the upstream regulator, network of the particular target gene, a most influential parent gene, wherein the most influential parent gene comprises a mutated parent gene most likely to have impacted the expression of the target gene compared to the other parent genes in the upstream regulatory network of the particular gene; and
reporting those target genes that have said significant inconsistencies as aberrant or dysregulated genes, wherein said reporting comprises an identification of the most influential target gene for one or more of the target genes that have said significant inconsistencies.

2. (canceled)

3. (canceled)

4. The method of claim 1, wherein said non-linear function is determined based on the gene's epigenetic information obtained from said measurement-based omics data and the gene's regulatory sub-network status.

5. The method of claim 4, wherein said non-linear function is determined using a global depth penalization mechanism which captures the potentially stronger impact of regulatory genes in the sub-network.

6. The method of claim 1, wherein the patient-specific information includes cancer sample data such as RNA expression data, CNV data, methylation data and somatic mutation data.

7. An integrated, unified network for identifying significant deviations and inconsistencies in gene expression levels in individual patient samples, comprising;
a primary dataset of upstream regulatory parent gene information for each target gene obtained from curated biological network pathway information, said primary dataset located on a processor configured to receive said pathway information, and comprising a relationship between said target gene's expression level with said gene's genomic and epigenetic status, and said target gene's upstream transcriptional regulators;
a regulatory tree for each specific target gene that captures the relationship between the gene's expression level with said target gene's genomic and epigenetic status, and its upstream transcriptional regulators, said tree determined from said primary dataset;
a second dataset of measurement-based omics data comprising at least one of RNAseq expression data, copy number variation data, and DNA methylation data, said second dataset located on a processor configured to receive such data,
a non-linear function for each target gene; wherein the parameters of said non-linear function are determined using a modified Bayesian inference method;
a third dataset of patient-specific information relating to observed expression levels for the target genes and comprising a sequence of one or more parent genes in the determined regulatory sub-network of one or more of the target genes, said the patient-specific information including new cancer sample data;
wherein, expression levels of said target genes are determined utilizing said non-linear function, and relative patient-specific inconsistency scores are determined between said predicted and said observed expression levels for the target genes in a given sample; and
wherein activation and inconsistency scores are determined for all test samples whereby statistically significant associations between inconsistencies in said target gene expression level with the somatic mutations in the upstream regulatory network of that particular gene are identified by a process comprising the following steps: (i) calculating for each parent gene in the upstream regulatory network of the particular target gene for which a mutation has been identified, a functional impact score of a somatic mutation based at least in part on the calculated patient-specific inconsistency score, the genes in the upstream regulatory network of the particular target gene, and a set of genes comprising one or more mutations, an d(ii) determining, based on the calculated functional impact scores for two or more parent gene in the upstream regulatory network of the particular target gene, a most influential parent gene, wherein the most influential parent gene comprises a mutated parent gene most likely to have impacted the expression of the target gene compared to the other parent genes in the upstream regulatory network of the particular target gene.

8. (canceled)

9. (canceled)

10. The system of claim 7, wherein said non-linear function is determined based on the gene's epigenetic information obtained from said measurement-based omics data and the gene's regulatory sub-network status.

11. The system of claim 10, wherein said non-linear function determined by said modified Bayesian method incorporates a global depth penalization mechanism which captures the potentially stronger impact of regulatory genes in the sub-network.

12. The system of claim 7, wherein the patient-specific information includes cancer sample data such as RNA expression data, CNV data, methylation data and somatic mutation data.
